(19) United States
(12) Patent Application Publication
(10) Pub. No.: US 2023/0278179 A1
(43) Pub. Date: Sep. 7, 2023

(54) METHOD OF ADJUSTING ENERGY OUTPUT FOR AN ELECTRIC NAIL GUN, AND ELECTRIC NAIL GUN IMPLEMENTING THE SAME

(71) Applicant: BASSO INDUSTRY CORP., Taichung (TW)

(72) Inventors: Sheng-Kai Chen, Taichung (TW); Hung-Da Chen, Taichung (TW)

(73) Assignee: BASSO INDUSTRY CORP., Taichung (TW)

(21) Appl. No.: 18/175,781

(22) Filed: Feb. 28, 2023

(30) Foreign Application Priority Data
Mar. 4, 2022 (TW) 111108010

(51) Int. Cl. B25C 1/06; B25C 1/00

(52) U.S. Cl. CPC B25C 1/06; B25C 1/008

(57) ABSTRACT

A method of adjusting an energy output for an electric nail gun including a controller, a motor, a flywheel that co-rotates with the motor, an impact member configured to receive energy of the flywheel to hit a nail, an operation component, an adjust component and a plurality of indicators is provided. The controller has a plurality of energy modes related to controlling the motor to drive the flywheel to rotate with different rotational speeds, respectively. When the adjust component is activated, the controller switches a currently-active energy mode to a next one of the energy modes, and lights up the indicators in a manner corresponding to the next one of the energy modes. When the operation component is activated, the controller controls the motor to rotate in the currently-active energy mode to drive the flywheel thus driving the impact member for firing the nail.

### CROSS-REFERENCE TO RELATED APPLICATION

This application claims priority to Taiwanese Invention Patent Application No. 111108010, filed on Mar. 4, 2022.

### FIELD

The disclosure relates to a method of adjusting an energy output for an electric tool, and more particularly to a method of adjusting an energy output for an electric nail gun, and an electric nail gun implementing the method.

### BACKGROUND

When a conventional electric nail gun is used to execute a nail firing action, since the firing power is difficult to be adjusted in a timely manner, the nail may be fired such that it goes too deep into the material or even break the material if the material is soft (e.g., a soft wood), Although the firing pin may be shortened to adapt for soft materials, the nail may not be completely fired into the material if the material is hard.

A conventional solution to the abovementioned problem is to install an exterior frame on the electric nail gun where a length of the exterior frame may be adjusted so as to adjust a depth to which the nail is fired into a target material (i.e., the depth to which the nail penetrates, which will be referred to as “nail depth” hereinafter). When the target material is soft, the exterior frame may be adjusted to be longer (e.g., by turning a screw or adjusting a knob of the exterior frame) so as to reduce the nail depth; when the target material is hard, the exterior frame may be adjusted to be shorter so as to extend the nail depth.

However, the conventional solution requires a user to manually turn the screw or adjust the knob of the exterior frame every time when there is a need to adjust the nail depth, making the electric nail gun inconvenient to use.

### SUMMARY

Therefore, an object of the disclosure is to provide an electric nail gun and a method of adjusting an energy output for the same that can alleviate at least one of the drawbacks of the prior art.

According to the disclosure, a method of adjusting an energy output for an electric nail gun including a motor, a flywheel that co-rotates with the motor, an impact member configured to receive rotational energy of the flywheel to hit a nail, an operation component, an adjust component and a plurality of indicators is provided. The method includes steps of: providing a controller of the electric nail gun that has a plurality of energy modes, where the energy modes are arranged in an order and respectively correspond to different displaying manners of the indicators, and where the energy modes are related to controlling the motor to drive the flywheel to rotate with different rotational speeds, respectively; by the controller, upon receipt of a switch signal that is outputted by the adjust component when the adjust component is being activated, switching a currently-active energy mode which the electric nail gun is currently operating in from one of the energy modes to a next one of the energy modes, and lighting up the indicators in one of the displaying manners that corresponds to the next one of the energy modes; and by the controller, when the operation component is being activated, controlling the motor to rotate in the currently-active energy mode to drive the flywheel thus driving the impact member for firing the nail.

According to the disclosure, an electric nail gun includes a motor configured to receive electric energy from an electric power source to rotate, a flywheel configured to co-rotate with the motor, an impact member configured to receive rotational energy of the flywheel to hit a nail, whereby firing the nail, an operation component configured to output an operation signal when being activated, an adjust component configured to output a switch signal when being activated, a plurality of indicators, and a controller electrically connected to the motor, the operation component, the adjust component and the indicators. The controller has a plurality of energy modes, where the energy modes are arranged in an order and respectively correspond to different displaying manners of the indicators, and where the energy modes are related to controlling the motor to drive the flywheel to rotate with different rotational speeds, respectively. The controller is configured to, upon receipt of a switch signal that is outputted by the adjust component when the adjust component is being activated, switch a currently-active energy mode which the electric nail gun is currently operating in from one of the energy modes to a next one of the energy modes, and light up the indicators in one of the displaying manners that corresponds to the next one of the energy modes. The controller is further configured to, when the operation component is being activated, control the motor to rotate in the currently-active energy mode to drive the flywheel thus driving the impact member for firing the nail.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an electric nail gun according to an embodiment of the disclosure.

FIG. 2 is a partial sectional view partially illustrating the embodiment.

FIG. 3 is a sectional view of the embodiment from an opposite side of FIG. 2.

FIG. 4 is a block diagram illustrating a circuit of the embodiment.

FIG. 5 is a schematic view illustrating a panel of the embodiment.

FIG. 6 is a flow chart illustrating a method of adjusting an energy output for an electric nail gun according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

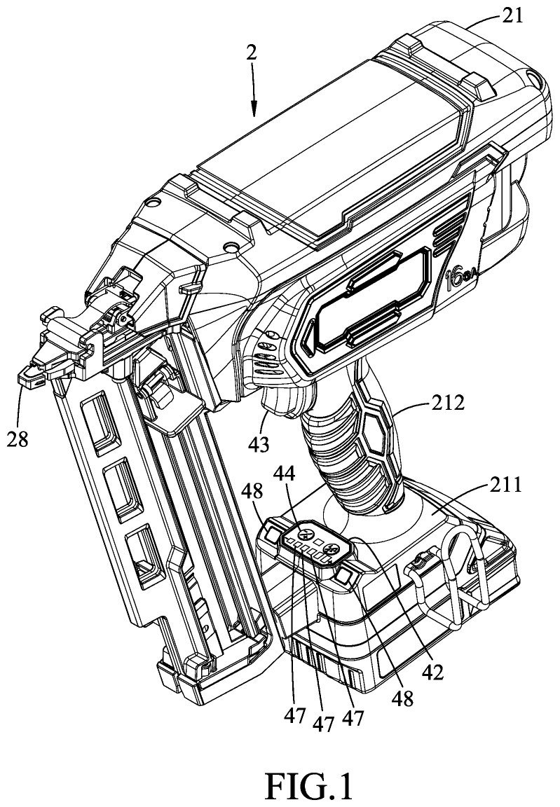

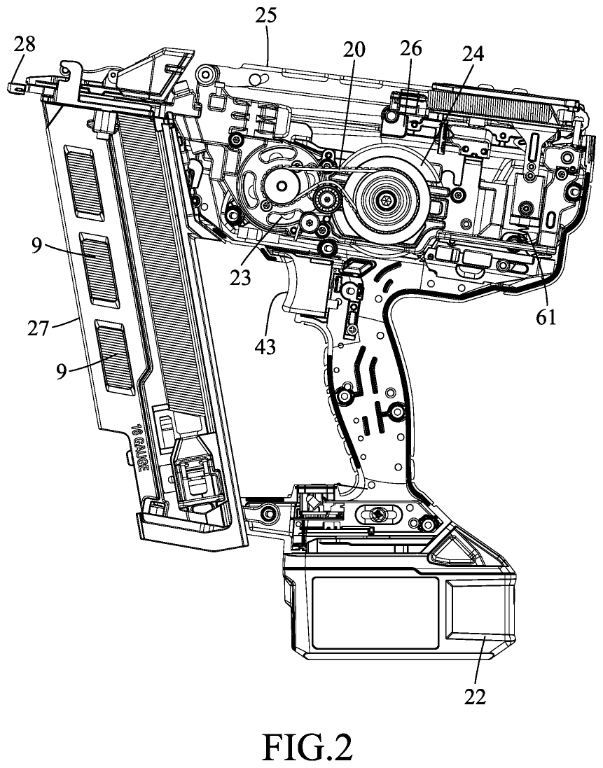

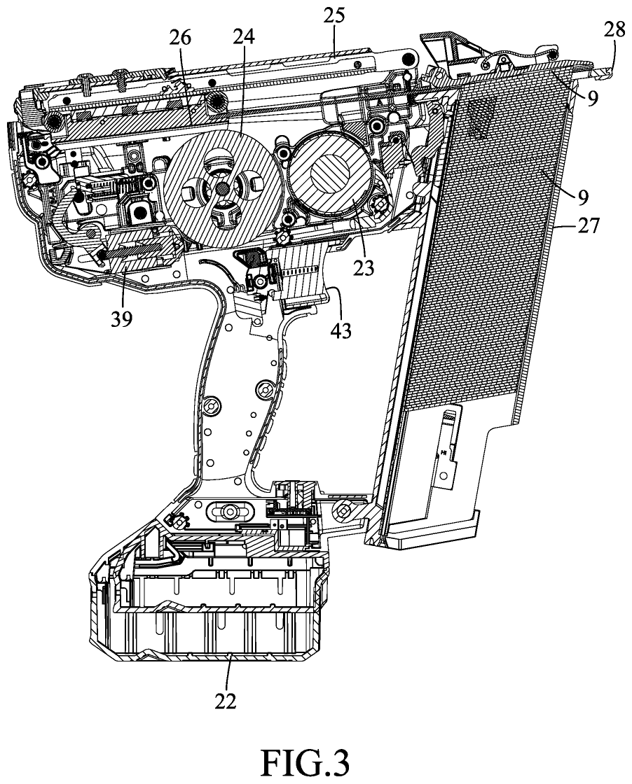

Referring to FIGS. 1 to 3, an electric nail gun 2 adapted to contain a plurality of nails 9 according to an embodiment of the disclosure is provided. The electric nail gun 2 includes a main frame 21, a battery 22, a motor 23, a belt 20, a flywheel 24 driven by the belt 20 to co-rotate with the motor 23, a swing arm 25 adjacent to the flywheel 24, an impact member 26 mounted to the swing arm 25, a magazine 27 adapted to contain the nails 9 therein, and a safety switch 28.

The main fame 21 includes a base 211 and a handle 212, and is adapted to dispose the battery 22, the magazine 27, the motor 23, the belt 20, the flywheel 24, the swing arm 25 and the impact member 26.

The motor 23 is configured to receive electric energy from the battery 22 to rotate, and is further configured to drive the flywheel 24, with the belt 20, to co-rotate with the motor 23. In this embodiment, the battery 22 serves as an electric power source of the electric nail gun 2, but this disclosure is not limited in this respect. For example, utility power may serve as the electric power source of the electric nail gun 2 in other embodiments, and the electric nail gun 2 receives electric power from an electrical outlet through a power cord for providing the electric energy to the motor 23. The impact member 26 is configured to contact the flywheel 24 when the swing arm 25 is at a firing position to receive a throwing force of the flywheel 24, so the impact member 26 is driven by the flywheel 24 to slide rapidly and hit one of the nails 9 (i.e., transferring the rotational energy of the flywheel 24 to a kinetic energy of the one of the nails 9). The abovementioned method of firing nails is well-known to this industry and will not be described in further detail for the sake of brevity.

The motor 23 may be a brushless DC motor (BLDC). The throwing force for hitting the nails 9 depends on the rotational energy of the flywheel 24, and the rotational energy of the flywheel 24 depends on a rotational speed of the flywheel 24 driven by the motor 23 with the belt 20. Therefore, adjusting the motor 23 to rotate with different rotational speeds may adjust the rotational energy of the flywheel 24 that drives the impact member 26 to hit the nails 9, thus adjusting the kinetic energy of the nails 9 and a depth to which the nails 9 are fired into a target object (i.e., a nail depth).

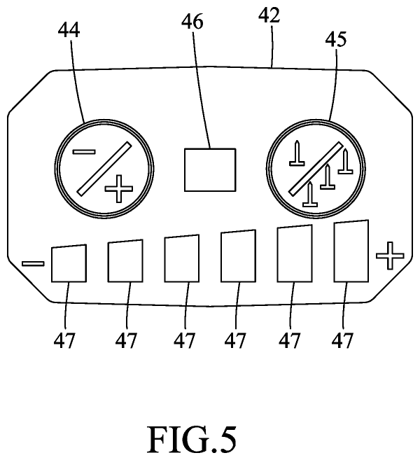

Further referring to FIG. 5, the electric nail gun 2 further includes a panel 42, an operation component 43, an adjust component 44, a function component 45, an indication light 46, a plurality of indicators 47 and at least one tool light 48. In this embodiment, two tool lights 48 are used for illustration. The operation component 43, the adjust component 44 and the function component 45 may be realized using buttons, switches, triggers, knobs, any other suitable components, or any combination thereof.

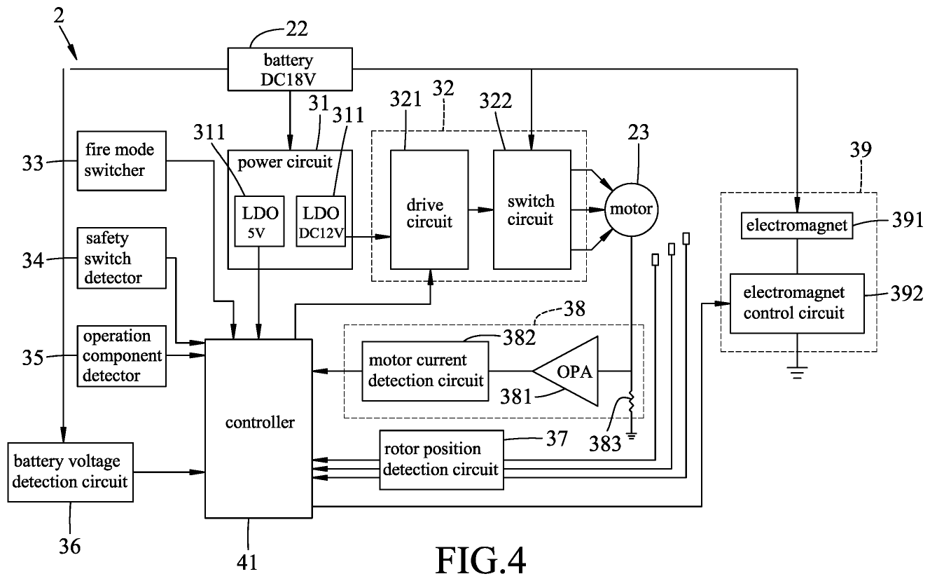

Further referring to FIG. 4, the electric nail gun 2 further includes a power circuit 31, a drive module 32 including a drive circuit 321, a fire mode switcher 33, a safe switch detector 34, an operation component detector 35, a battery voltage detection circuit 36, a rotor position detection circuit 37, a current detection module 38, an electromagnet module 39, and a controller 41 electrically connected to the abovementioned components, modules and circuits 31-39.

The power circuit 31 is configured to stabilize and transform the electric energy provided by the battery 22 (e.g., DC 18V) for use by other internal circuits of the electric nail gun 2. The power circuit 31 may include, for example, two low-dropout regulators (LDOs) 311, each providing a different voltage from the other (e.g., 5V and 12V), and providing electric energy respectively for the controller 41 and the drive circuit 321 of the drive module 32.

In this embodiment, the drive module 32 further includes a switch circuit 322. The drive circuit 321 is configured to receive a pulse-width modulation (PWM) signal outputted by the controller 41, and control the switch circuit 322 to drive the motor 23 to rotate at a desired rotational speed based on a duty ratio of the PWM signal. The switch circuit 322 may be implemented using a metal-oxide-semiconductor field-effect transistor (MOSFET) switch.

The fire mode switcher 33 is configured to switch operation of the electric nail gun 2 between a single firing mode and a continuous firing mode upon receipt of a function signal that is outputted by the function component 45 when the function component 45 is being activated. The controller 41 implements different control processes respectively for the two different firing modes. When implementing the single firing mode, the controller 41 enables the electric nail gun 2 to execute a one-time nail firing action. For example, when the operation component 43 is being pressed while the safety switch 28 has been pressed, a nail firing action is executed only once, and then both the safety switch 28 and the operation component 43 have to be released for preparing the next nail firing action. When implementing the continuous firing mode, the controller 41 enables the electric nail gun 2 to execute continuous nail firing actions. For example, the nail firing action is executed once every time the safety switch 28 is being pressed while the operation component 43 is continuously being pressed.

The safety switch detector 34 is configured to detect whether the safety switch 28 is being pressed. The operation component detector 35 is configured to detect whether the operation component 43 is being pressed. In this embodiment, when the electric nail gun 2 operates in the single firing mode, a user needs to press the safety switch 28, and then press the operation component 43 to perform the nail firing action.

The battery voltage detection circuit 36 is electrically connected between the battery 22 and the controller 41. The battery voltage detection circuit 36 is configured to detect voltage of the battery 22 for the controller 41 to adjust the duty ratio of the PWM signal sent to the drive circuit 321 based on the voltage of the battery 22 thus detected, so as to maintain the motor 23 to rotate at the desired rotational speed.

The rotor position detection circuit 37 is configured to detect a rotor position of the motor 23, allowing the controller 41 to acquire a rotational speed of the motor 23. The rotor position detection circuit 37 may be implemented using a Hall sensor.

The current detection module 38 includes an operational amplifier (OPA) 381, a motor current detection circuit 382 and a shunt resistor 383. The current detection module 38 is configured to detect current of the motor 23 for the controller 41 to monitor the current of the motor 23. For example, when the current of the motor 23 is too large, the controller 41 may control the drive circuit 321 to stop operation of the motor 23, which serves as an over-current protection.

The electromagnet module 39 includes an electromagnet 391 and an electromagnet control circuit 392. The electromagnet control circuit 392 is controlled by the controller 41 to switch the electromagnet 391 between a relaxation state and an excitation state by providing or not providing an electric current to flow through (a winding of) the electromagnet 391. When the electric nail gun 2 is not executing the nail firing action, the swing arm 25 is released, and a pushing force from a spring 61 holds the swing arm 25 in a non-firing position. When the electric nail gun 2 is executing the nail firing action, the swing arm 25 is moved by the electromagnet 391 to the firing position (i.e., the spring 61 is now compressed by the swing arm 25) for executing the nail firing action. Details of the implementation may refer to Taiwanese Patent Application No. 104133399 titled, “Driving Device of Electric Nailing Gun,” and Taiwanese Patent Application No. 108103566 titled, “Flying Wheel Type Electric Nail Gun Preventing Accidental Activation,” and will not be described herein for the sake of brevity.

In this embodiment, a unit configured to control contact and separation between the flywheel 24 and the impact member 26 is illustrated by, but is not limited to, the electromagnet 391 driving the swing arm 25. The unit may be other units performing similar functions. Related prior arts may refer to Taiwanese Patent No. 1349601 titled, “Rotary Kinetic Energy Clutch Device for Electric Nail Gun,” U.S. Pat. No. 9,744,657B2 titled, “Activation System Having Multi-angled Arm and Stall Release Mechanism,” and U.S. patent Ser. No. 11/097,408B2 titled, “Driving Tool.”

The controller 41 is configured to control the drive circuit 321 to drive the motor 23 to operate. The controller 41 may be a circuit with functions of analog-to-digital conversion (A/D conversion), input/output detection (I/O detection), communication transmission, and pulse-width modulation (PWM) output etc., such as a microcontroller unit (MCU).

The panel 42 is located over a front end portion of the base 211 of the main frame 21, and is located below the handle 212 of the main frame 21, allowing the user to conveniently look at and operate the panel 42.

The operation component 43 is located at a front side of an upper portion of the handle 212 and is configured to output an operation signal when being activated by the user pressing or pulling the operation component 43.

The adjust component 44 and the function component 45 are respectively located on the left and right sides of the panel 42, and the adjust component 44 is configured to output a switch signal when being activated (e.g., by pressing or touching) by the user.

The indication light 46 is located on the panel 42, and is between the adjust component 44 and the function component 45. The indication light 46 is configured to indicate an operation status of the electric nail gun 2. In this embodiment, the indication light 46 displays green light when the electric nail gun 2 is functioning normally, and displays red blinking light when the electric nail gun 2 is malfunctioning.

The indicators 47 are located on the panel 42 in front of the adjust component 44, the indication light 46 and the function component 45, and are arranged from left to right. The controller 41 has a plurality of energy modes that respectively correspond to different displaying manners of the indicators 47, and the indicators 47 are configured to light up by the controller 41 in one of the displaying manners that corresponds to a currently-active energy mode, which is one of the energy modes that the electric nail gun 2 is currently operating in. The energy modes are related to controlling the motor 23 to drive the flywheel 24 with the belt 20 to rotate with different rotational speeds, respectively. The indicators 47 may be implemented using light emitting diodes (LEDs).

In this embodiment, there are six indicators 47 respectively correspond to six energy modes for illustration. A first one of the energy modes corresponds to lighting up the first one of the indicators 47 from the left, a second one of the energy modes corresponds to lighting up the first two of the indicators 47 from the left and so on. Following this pattern, a sixth one of the energy modes corresponds to lighting up all six of the indicators 47. The number of the indicators 47, the number of the energy modes, and the displaying manners of the indicators 47 corresponding to the energy modes may alter and are not limited to the abovementioned example.

The tool lights 48 are located at the front end portion of the base 211 and are respectively on the left and right sides of the panel 42. The tool lights 48 are installed as facing up front (i.e., facing the direction of a position of nail firing) and emit light to provide lighting for the position of nail firing.

The controller 41 is electrically connected to the operation component 43, the adjust component 44, the function component 45, the indication light 46, the indicators 47 and the tool lights 48. The controller 41 is further configured to, upon receipt of the operation signal and/or the switch signal respectively from the operation component 43 and the adjust component 44, implement a method of adjusting an energy output for an electric nail gun.

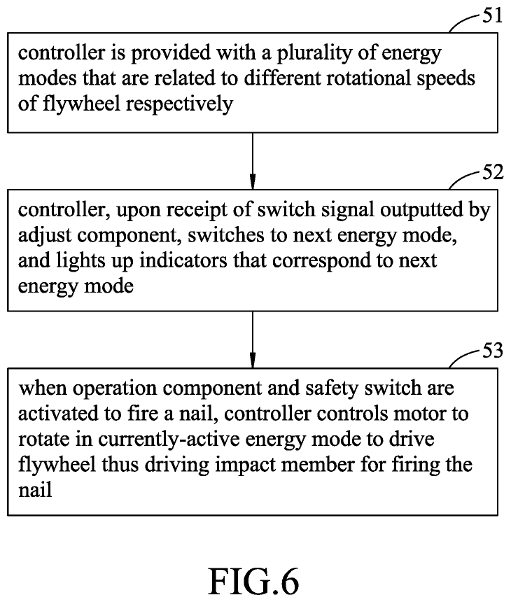

Further referring to FIG. 6, the method of adjusting the energy output for the electric nail gun according to an embodiment of the disclosure is implemented by the electric nail gun 2 in the following steps.

In step 51, the controller 41 is provided with the plurality of energy modes that are arranged in an order and that respectively correspond to different displaying manners of the indicators 47. The energy modes are related to controlling the motor 23 to drive the flywheel 24 with the belt 20 to rotate with different rotational speeds, respectively. In this embodiment, for each of the energy modes, the corresponding one of the different displaying manners includes lighting up the corresponding one of the indicators 47.

The controller 41 may set one of the energy modes as a default mode, and the controller 41 operates in the default mode when the electric nail gun 2 is being powered up or rebooted.

In some embodiments, the order of arrangement of the energy modes may be in ascending or descending order of the different rotational speeds. The energy modes include a greatest energy mode that is related to a greatest one of the different rotational speeds of the flywheel 24, and the default mode is one of the energy modes other than the greatest energy mode in this embodiment. The energy modes may be divided into three sections as a higher section, a middle section and a lower section, and the default energy mode may be one of the energy modes that corresponds to the middle section. For example, the default energy mode may be one of (n) energy modes in the middle section, where (n) is equal to (N) divided by three, rounding to the nearest integer, and (N) is a total number of the energy modes. In this embodiment, (N) is equal to six so the default energy mode may be either a third one of the energy modes or a fourth one of the energy modes. The third one of the energy modes is set as the default energy mode in this embodiment.

In step 52, the controller 41, upon receipt of a switch signal that is outputted by the adjust component 44 when the adjust component 44 is being activated, switches the currently-active energy mode to a next one of the energy modes, and lights up the indicators 47 in one of the displaying manners that corresponds to the next one of the energy modes.

In this embodiment, the order of arrangement of the energy modes corresponds to an ascending order of the different rotational speeds of the flywheel 24, and switching the currently-active energy mode is performed by cycling through each of the energy modes in the order of arrangement of the energy modes. For example, cycling through may involve switching from one of the energy modes that provides the lowest rotational energy (i.e., the lowest rotational speed) to one of the energy modes that provides the highest rotational energy (i.e., the highest rotational speed) in the ascending order of the different rotational speeds, and then switching back to one of the energy modes that provides the lowest rotational energy so as to continue the cycle.

The indicators 47 respectively correspond to the energy modes and are arranged based on the order of arrangement of the energy modes. When cycling through each of the energy modes in the order of arrangement of the energy modes, the controller 41 controls the indicators 47 to light up the corresponding one of displaying manners by cycling through the different displaying manners.

In step 53, when the safety switch 28 and the operation component 43 are activated in a correct manner to fire the nail, the controller 41 controls the motor 23 to rotate in the currently-active energy mode to drive the flywheel 24 thus driving the impact member 26 for firing one of the nails 9. For example, when the operation component 43 is being activated while the safety switch 28 has been activated in the single firing mode, or when the safety switch 28 is being activated while the operation component 43 is continuously being activated in the continuous firing mode, the controller 41 controls the motor 23 to rotate in the currently-active energy mode to drive the flywheel 24 thus driving the impact member 26 for firing one of the nails 9.

In the single firing mode, the controller 41 may light up the tool lights 48 when the safety switch 28 is being activated, and may turn off the tool lights 48 after the safety switch 28 is released for longer than a predetermined time period. In the continuous firing mode, the controller 41 may light up the tool lights 48 when the operation component 43 is being activated, and may turn off the tool lights 48 after the operation component 43 is released for longer than the predetermined time period.

An actual operation process of the embodiment is illustrated as follows. When the user reboots the electric nail gun 2 or inserts the battery 22 into the electric nail gun 2, the controller 41 switches to the default mode (e.g., the default mode being the third one of the energy modes), and lights up the leftmost three of the indicators 47, indicating that the third one of the energy modes is the currently-active energy mode, and that the nails 9 would be fired with the flywheel 24 rotating at a third rotational speed, which is one of the different rotational speeds that corresponds to the third one of the energy modes. Then, when the user presses the safety switch 28 during, for example, the single firing mode, the controller 41 controls the tool lights 48 to light up to provide lighting for the user when the nail firing action is executed. And then, when the user presses the operation component 43, the controller 41 controls the drive circuit 321 to operate in the third one of the energy modes, thus driving the motor 23 to rotate at the third rotational speed, and fires one of the nails 9.

When the user intends to adjust the nail depth (i.e., adjust the rotational speed of the flywheel 24), the user may press the adjust component 44. Each time the adjust component 44 is being pressed, the currently-active energy mode will be switched to the next one of the energy modes. For example, when the electric nail gun 2 operates in the third one of the energy modes (i.e., the flywheel 24 rotating at the third rotational speed and the leftmost three of the indicators 47 being lighted up), pressing the adjust component 44 once will switch the currently-active energy mode to the fourth one of the energy modes (i.e., the flywheel 24 rotating at a fourth rotational speed and the leftmost four of the indicators 47 being lighted up). When the electric nail gun 2 operates in the sixth one of the energy modes (i.e., the flywheel 24 rotating at a sixth rotational speed and all six of the indicators 47 being lighted up), pressing the adjust component 44 once will switch the currently-active energy mode to the first one of the energy modes (i.e., the flywheel 24 rotating at a first rotational speed and only the leftmost one of the indicators 47 being lighted up).

In summary, the controller 41 has a plurality of energy modes, and the controller 41 switches to the next one of the energy modes when the adjust component 44 is being activated. The user may adjust the nail depth by switching between different rotational speeds of the flywheel 24 and by pressing the adjust component 44, thus avoiding the need to turn a screw or adjust a knob. Furthermore, since the energy modes respectively correspond to the different displaying manners of the indicators 47, the user may easily identify the currently-active energy mode by checking which one of the displaying manners the indicators 47 are currently displaying in.

The controller 41 sets one of the energy modes as the default mode, and the default mode is not the greatest energy mode. This may prevent the user from entering the greatest energy mode that may provide energy output exceeding the actual needed energy output at the moment of powering up the electric nail gun 2. Since using the energy output that exceeds the actual needed energy output may result in a waste of electric energy, and may increase wear and tear of components, having the default mode being one of the energy modes other than the greatest energy mode may reduce unnecessary power consumption and improve the product's lifespan.

Additionally, setting the default mode as one of the energy modes in the middle section applies to most nail firing situations. When the user needs to have a higher energy output, the user may simply switch to the next one of the energy modes by activating the adjust component 44.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of adjusting an energy output for an electric nail gun, the electric nail gun including a motor, a flywheel that co-rotates with the motor, an impact member configured to receive rotational energy of the flywheel to hit a nail, an operation component, an adjust component and a plurality of indicators, the method comprising steps of:
providing a controller of the electric nail gun that has a plurality of energy modes, where the energy modes are arranged in an order and respectively correspond to different displaying manners of the indicators, and where the energy modes are related to controlling the motor to drive the flywheel to rotate with different rotational speeds, respectively;
by the controller, upon receipt of a switch signal that is outputted by the adjust component when the adjust component is being activated, switching a currently-active energy mode which the electric nail gun is currently operating in from one of the energy modes to a next one of the energy modes, and lighting up the indicators in one of the displaying manners that corresponds to the next one of the energy modes; and
by the controller, when the operation component is being activated, controlling the motor to rotate in the currently-active energy mode to drive the flywheel thus driving the impact member for firing the nail.

2. The method as claimed in claim 1, wherein the controller sets one of the energy modes as a default mode, and said method further comprising a step of, by the controller, operating in the default mode when the electric nail gun is being powered up or rebooted.

3. The method as claimed in claim 2, wherein the energy modes include a greatest energy mode that is related to a greatest one of the different rotational speeds, and the default mode is one of the energy modes other than the greatest energy mode.

4. The method as claimed in claim 2, wherein the order of arrangement of the energy modes is in ascending or descending order of the different rotational speeds, and the default mode is one of the energy modes that is in a middle section of the order of arrangement of the energy modes.

5. The method as claimed in claim 1, wherein the order of arrangement of the energy modes corresponds to an ascending order of the different rotational speeds, and the step of switching the currently-active energy mode is performed by cycling through each of the energy modes in the order of arrangement of the energy modes.

6. The method as claimed in claim 5, wherein the indicators respectively correspond to the energy modes and are arranged based on the order of arrangement of the energy modes, and, for each of the energy modes, the corresponding one of the different displaying manners includes lighting up the corresponding one of the indicators; and
wherein, when cycling through each of the energy modes in the order of arrangement of the energy modes, the controller controls the indicators to light up in the corresponding one of the different displaying manners by cycling through the different displaying manners.

7. The method as claimed in claim 1, the electric nail gun further including at least one tool light and a safety switch electrically connected to the controller, and said method further comprising a step of, by the controller, when the safety switch is being activated, lighting up the at least one tool light.

8. An electric nail gun comprising:
a motor configured to receive electric energy from an electric power source to rotate;
a flywheel configured to co-rotate with said motor;
an impact member configured to receive rotational energy of said flywheel to hit a nail, whereby firing the nail;
an operation component configured to output an operation signal when being activated;
an adjust component configured to output a switch signal when being activated;
a plurality of indicators; and
a controller electrically connected to said motor, said operation component, said adjust component and said indicators, and having a plurality of energy modes, where the energy modes are arranged in an order and respectively correspond to different displaying manners of said indicators, and where the energy modes are related to controlling said motor to drive said flywheel to rotate with different rotational speeds, respectively;
wherein said controller is configured to, upon receipt of the switch signal from said adjust component, switch a currently-active energy mode which said electric nail gun is currently operating in from one of the energy modes to a next one of the energy modes, and light up said indicators in one of the displaying manners that corresponds to the next one of the energy modes; and
wherein said controller is configured to, upon receipt of the operation signal from said operation component, control said motor to rotate in the currently-active energy mode to drive said flywheel thus driving said impact member for firing the nail.

9. The electric nail gun as claimed in claim 8, wherein said controller is configured to set one of the energy modes as a default mode and operate in the default mode when said electric nail gun is being powered up or rebooted.

10. The electric nail gun as claimed in claim 9, wherein the energy modes include a greatest energy mode that is related to a greatest one of the different rotational speeds, and the default mode is one of the energy modes other than the greatest energy mode.

11. The electric nail gun as claimed in claim 9, wherein the order of arrangement of the energy modes is in ascending or descending order of the different rotational speeds, and the default mode is one of the energy modes that is in a middle section of the order of arrangement of the energy modes.

12. The electric nail gun as claimed in claim 8, wherein the order of arrangement of the energy modes corresponds to an ascending order of the different rotational speeds, and the step of switching the currently-active energy mode is performed by cycling through each of the energy modes in the order of arrangement of the energy modes.

13. The electric nail gun as claimed in claim 12, wherein said indicators respectively correspond to the energy modes and are arranged based on the order of arrangement of the energy modes, and, for each of the energy modes, the corresponding one of the different displaying manners includes lighting up the corresponding one of said indicators; and
wherein, when cycling through each of the energy modes in the order of arrangement of the energy modes, said controller is configured to control said indicators to light up in the corresponding one of the different displaying manners by cycling through the different displaying manners.

14. The electric nail gun as claimed in claim 8, further comprising at least one tool light and a safety switch electrically connected to said controller, and said controller is further configured to, when said safety switch is being activated, lighting up said at least one tool light.
